(19) United States
(12) Patent Application Publication
(10) Pub. No.: US 2015/0213431 A1
(43) Pub. Date: Jul. 30, 2015

(54) Electronic Gifting System

(71) Applicant: Wonder Technologies, Inc., Laguna Beach, CA (US)

(72) Inventors: Gerry Goldstein, Laguna Niguel, CA (US); Anush L. Singh, Keller, TX (US)

(21) Appl. No.: 14/553,264

(22) Filed: Nov. 25, 2014

Related U.S. Application Data
(63) Continuation of application No. 61/908,610, filed on Nov. 25, 2013.

(51) Int. Cl. G06Q 20/22; G06Q 20/02

(52) U.S. Cl. CPC G06Q 20/22; G06Q 20/02

(57) ABSTRACT

Implementations of the present disclosure are directed to a method, system, and computer-readable medium for receiving a request by a donor to purchase a scrip (e.g., an electronic gift card) for a recipient in a respective amount, wherein the scrip can be applied to a purchase by the recipient from a merchant associated with the scrip; notifying the recipient of the scrip; receiving the recipient's acceptance of the scrip in response to the notification, wherein the acceptance indicates an account of the recipient; debiting the amount from an account of the donor; electronically monitoring over time at least one of an account of the merchant and the account of the recipient, to identify a purchase from the merchant by the recipient; and based on identifying the purchase, crediting the account of the recipient by a first amount based on the amount of the scrip.

### CROSS-REFERENCE TO RELATED APPLICATIONS

This application claims priority to and the benefit of, and incorporates herein by reference in its entirety, U.S. Provisional Patent Application No. 61/908,610, entitled “Electronic Gifting System,” which was filed on Nov. 25, 2013.

### BACKGROUND

The present disclosure relates to electronic commerce and, in particular, to electronic gifting systems.

In general, a gift card is a scrip or restricted monetary equivalent that is issued by banks or retailers for use as a non-monetary gift. A gift card relieves the donor of the gift card from the responsibility of selecting a specific gift. The recipient of the gift card may use the card to purchase goods or services from one or more businesses associated with the card. Electronic gift cards may be delivered to the recipient's mobile device or email address, and may be redeemed in-store or via online shopping, without requiring a visit to a brick and mortar location.

### SUMMARY

In general, one innovative aspect of the subject matter described in this specification can be embodied in methods that include the actions of receiving a request by a donor to purchase a scrip for a recipient in a respective amount, wherein the scrip can be applied to a purchase by the recipient from a merchant associated with the scrip; notifying the recipient of the scrip; receiving the recipient's acceptance of the scrip in response to the notification, wherein the acceptance indicates an account of the recipient; debiting the amount from an account of the donor; electronically monitoring over time at least one of an account of the merchant and the account of the recipient, to identify a purchase from the merchant by the recipient; and based on identifying the purchase, crediting the account of the recipient by a first amount based on the amount of the scrip. Other embodiments of this aspect include corresponding systems, apparatus, and computer programs.

These and other aspects can optionally include one or more of the following features. The scrip may be an electronic gift card. The scrip may represent a credit amount in a particular currency. After debiting the account of the donor, the amount of the scrip may be held in an escrow account. Crediting the account of the recipient may include releasing the first amount from the escrow account. The merchant associated with the scrip may be invoiced for a transaction fee. Payment for the transaction fee may be received. The recipient may be notified of the credit to the account of the recipient. The donor may be at least one individual, business entity, or organization; and the recipient may be at least one individual, business entity, or organization. The donor may be notified that the scrip has been redeemed. The notifying may be by electronic mail or short message service, or by multimedia messaging service. The recipient may be notified when a location of a client device of the recipient is within a geographical area of the merchant. A request may be received by the recipient to change the merchant to a different merchant; and based on the request to change the merchant, the scrip may be associated with the different merchant. A description of one or more merchants may be provided to the donor, wherein each of the merchants is located within a geographical area specified by the donor; a selection of one of the merchants by the donor may be received; and the selected merchant may be associated with the scrip. The first amount may be equal to the amount of the scrip or may be the lesser of an amount of the purchase and the amount of the scrip. The first amount may be deducted from the scrip amount; the account of the recipient may be electronically monitored over time to identify a subsequent purchase from the merchant by the recipient; and based on identifying the subsequent purchase, the account of the recipient may be credited by a second amount based on a remaining amount of the scrip. The second amount may be the lesser of an amount of the subsequent purchase and a remaining amount of the scrip. A wish list of merchants may be received from the recipient.

Particular embodiments of the subject matter described in this specification can be implemented so as to realize one or more of the following advantages. A donor wishing to purchase an electronic gift card or scrip for a recipient is able to select a merchant for the electronic gift card, regardless of whether the merchant offers a gift card or gift certificate program. The recipient is able to receive a notification of the electronic gift card. The recipient is able to make a purchase from the merchant with the recipient's own credit card. The systems and methods described herein are able to automatically identify and verify the transaction between the recipient and the merchant, with or without the active participation of the merchant in a gift card program. The recipient's credit card account may then receive a credit for the amount of the electronic gift card or the purchase, whichever amount is lower.

### DESCRIPTION OF THE DRAWINGS

FIG. 1 is a schematic illustration of an example electronic gift card system architecture in accordance with the present disclosure.

FIG. 2 is a schematic illustration of an example method for purchasing and redeeming an electronic gift card in accordance with the present disclosure.

FIGS. 3 and 4 are schematic illustrations of example steps associated with the method of FIG. 2.

FIG. 5 is a schematic illustration of an example method for matching a merchant name on a credit card statement with a merchant name as recognized by consumers, in accordance with the present disclosure.

FIGS. 6-14 are illustrative screenshots associated with the system of FIG. 1 and the method of FIG. 2.

### DETAILED DESCRIPTION

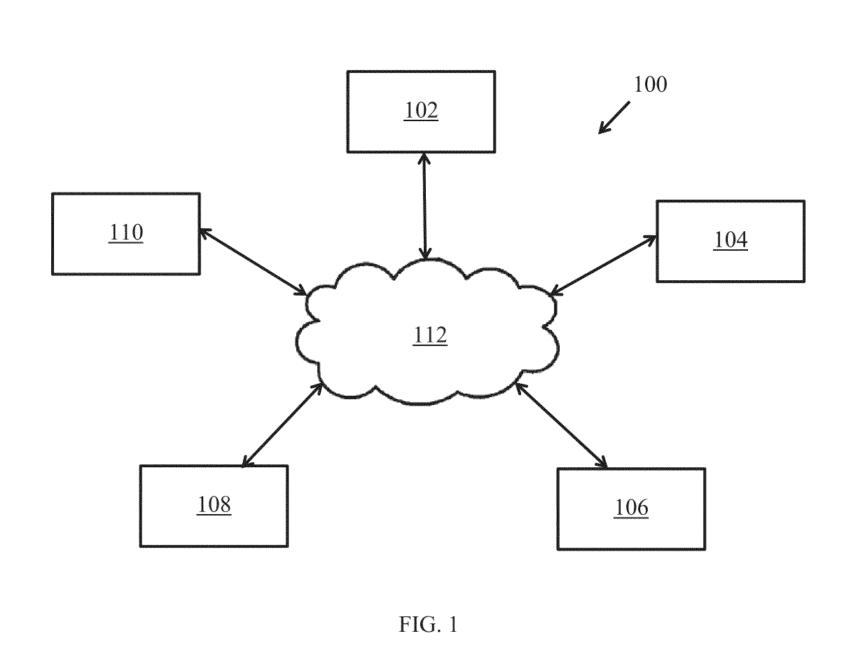

FIG. 1 is a schematic illustration of an example electronic gift card system 100. The system 100 includes a donor device 102 (e.g., a smart phone, smart watch, smart glasses, tablet computer, or personal computer), a transaction engine 104, a payment device 106, a recipient device 108 (e.g., a smart phone, smart watch, smart glasses, tablet computer, or personal computer), and a merchant device 110, each of which can have different capabilities and computer architectures. The donor device 102, the transaction engine 104, the payment device 106, the recipient device 108, and the merchant device 110 are data processing apparatus that are capable of communicating with one another through a network 112, such as the Internet and/or one or more local networks or intranets. The donor device 102 is associated with a donor or gift sender wishing to deliver an electronic gift card or scrip to a gift recipient who is associated with the gift recipient device 108. The donor device 102 and the recipient device 108 may each be independently any type of computing or electronic communication device, such as a personal computer, a workstation, or a mobile device (e.g., a smartphone). The transaction engine 104 may be any type of computing or communication device capable of receiving or sending information through the network 112. The payment device 106 is operated by or associated with one more financial institutions (e.g., one or more banks or credit card companies) to facilitate payments and transfer funds as necessary to complete transactions associated with the electronic gift card. In some implementations, the payment device 106 accesses or utilizes one or more Automated Clearing House (ACH) business accounts. The merchant device 110 is generally a computing or electronic communication device operated by or associated with one or more merchants. For example, the merchant device 110 may be a computer system or server operated by a store offering products or services online and/or at a brick and mortar location.

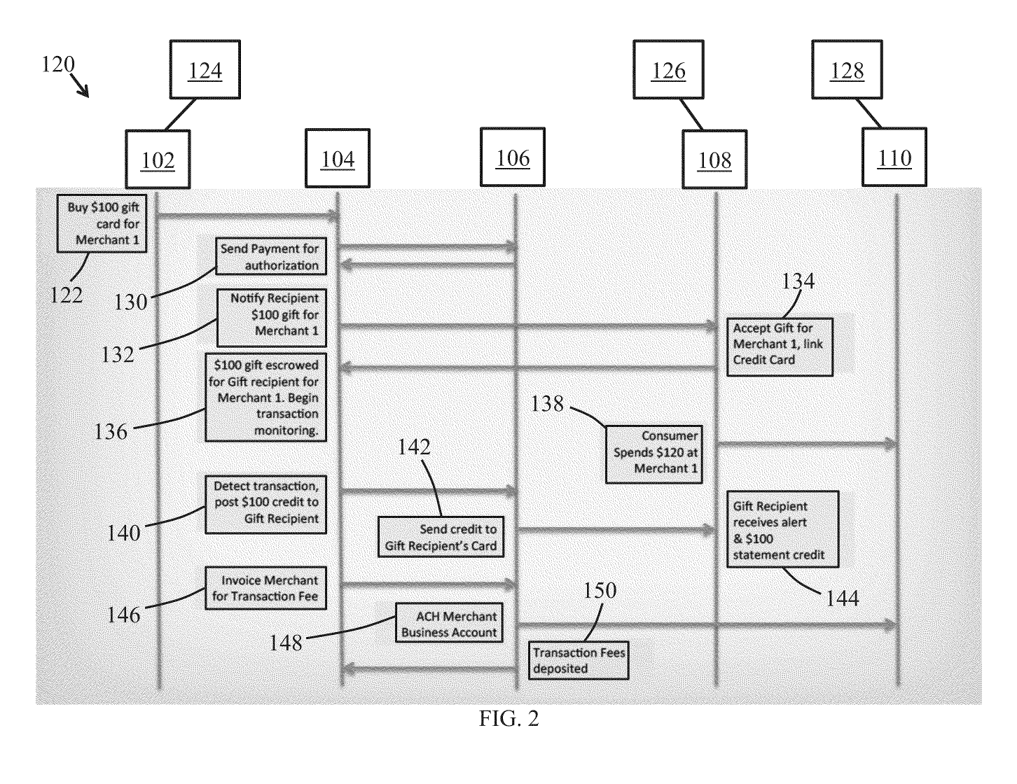

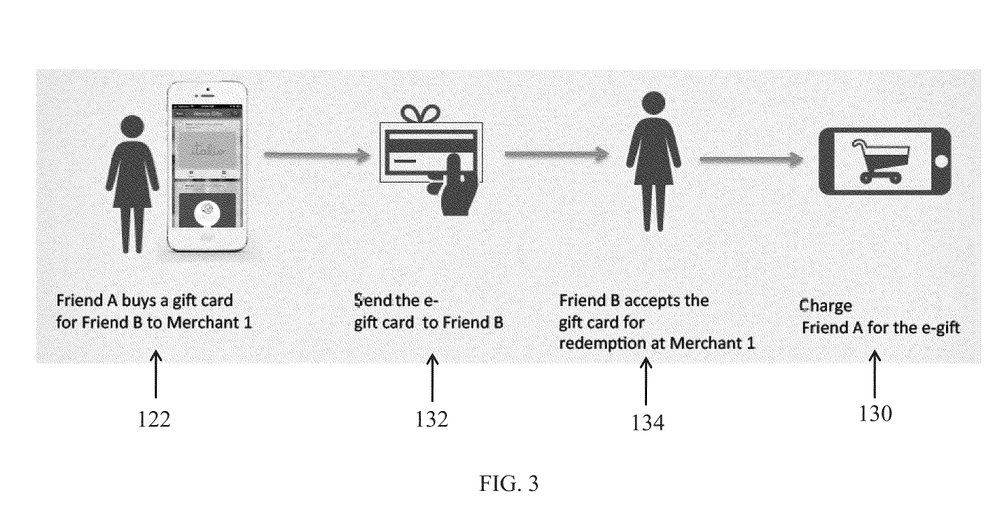

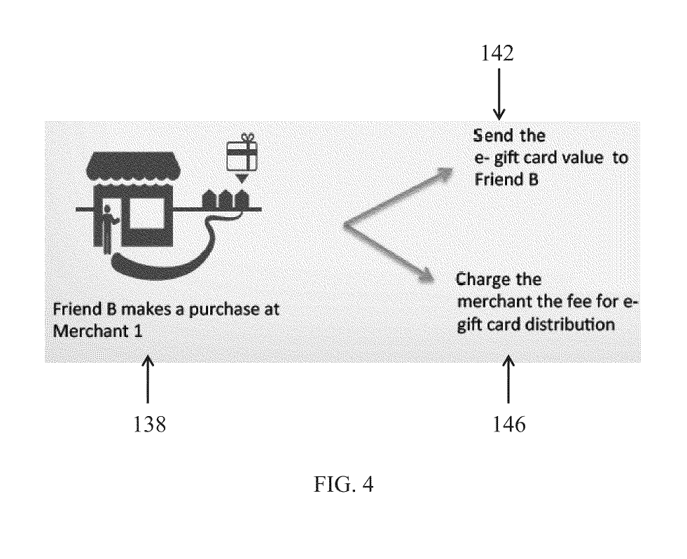

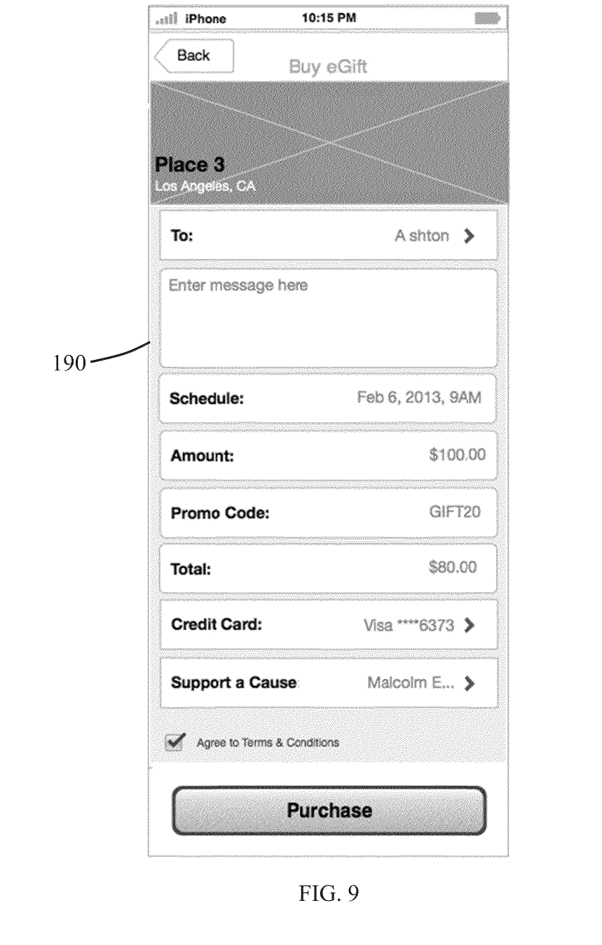

FIG. 2 is a schematic illustration of a method 120 that utilizes the system 100 to create and utilize an electronic gift card or scrip. The method 120 is further illustrated in FIGS. 3 and 4, which depict steps associated with purchasing and redeeming the electronic gift card, respectively. At step 122, a donor 124 uses the donor device 102 to purchase an electronic gift card for a recipient 126 to use in transactions with a merchant 128. The donor 124 and/or the recipient 126 may each be one or more people, business entities, and/or organizations. To make the purchase, the donor 124 specifies the recipient 126, the merchant 128, and an amount (e.g., $100 dollars) for the gift card using a natural language interface or a graphical user interface (GUI) of the donor device 102 such as, for example, the GUI shown in FIG. 9. The recipient 126 can be specified using the recipient's name, the recipient's image, a nickname, a telephone number, or an email address. Other ways of specifying the recipient 126 are possible. The donor 124 also provides credit card or other personal payment information necessary to make the purchase. The donor device 102 then transmits the information to the transaction engine 104 using, for instance, secure sockets layer (SSL). Upon receiving the purchase information from the donor device 102, the transaction engine 104 sends (step 130) payment information to the payment device 106 and receives authorization from the payment device 106 for the purchase. For example, the transaction engine 104 may send the donor's credit card information and the amount of the purchase to the payment device 106, and the payment device 106 may authorize the payment and debit the donor's credit card accordingly.

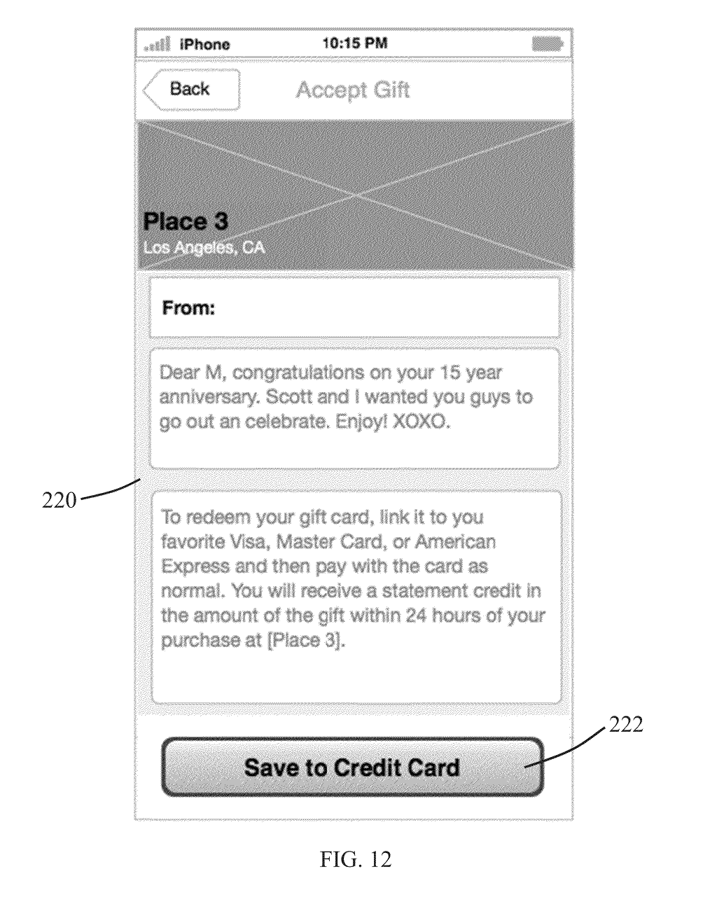

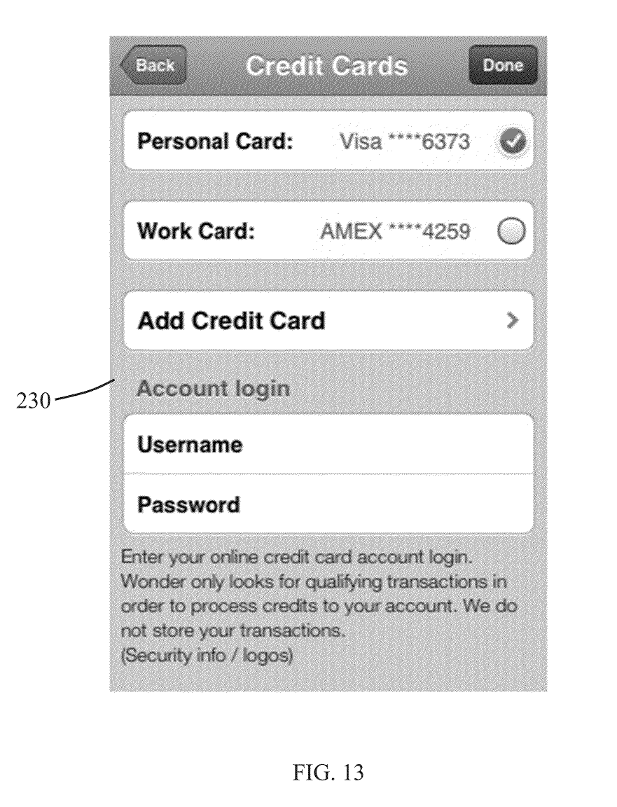

Once the donor 124 has paid for the electronic gift card, the transaction engine 104 notifies (step 132) the recipient 126 that the donor 124 has purchased the electronic gift card for the recipient 126. By way of illustration, the notification can be an email message, a text message, or other type of communication. The notification can provide information identifying the donor, the merchant, and the gift amount (see, e.g., FIG. 12). Using the recipient device 108, the recipient 126 provides (step 134) an indication to the transaction engine 104 that the electronic gift card has been received and accepted. For example, the recipient 126 can select a button 222 of FIG. 12. The recipient 126 also provides credit card information to the transaction engine 104 using, for example, the GUI of FIG. 13. At step 136, the transaction engine 104 places funds for the amount of the gift card in an escrow, which may be an escrow account established for the particular merchant 128.

At this point, the transaction engine 104 begins monitoring transactions by the merchant 128 and/or the recipient 126 to determine when the recipient 126 has made a transaction with the merchant 128. To perform this monitoring, the transaction engine 104 may have been given access by the merchant 128 to monitor the merchant's transactions (e.g., through the merchant device 110). Merchants who have authorized such monitoring are herein referred to as “partner merchants.” Alternatively or additionally, the transaction engine 104 may monitor the credit card transactions associated with the recipient's credit card information. Such monitoring may be necessary when the merchant 128 has not authorized the transaction engine 104 to monitor the merchant's transactions (i.e., when the merchant 128 is a “non-partner merchant”). To monitor the recipient's credit card transactions, the recipient 126 provides the transaction engine 104 with information necessary for the transaction engine 104 to access the recipient's credit card transaction information. For example, the recipient 126 may provide the transaction engine 104 with a username and/or a password that allows the transaction engine 104 to access the recipient's electronic credit card statement.

In some implementations, particularly with non-partner merchants, the transaction engine 104 monitors the recipient's credit card transactions and looks for names or codes associated with the merchant 128. For various reasons, the names or codes for the merchants in a credit card statement may not directly match the name of the merchant 128 recognized by consumers, such as the donor 124 or the recipient 126. Accordingly, the systems and methods described herein may utilize algorithms to decipher or interpret the names or codes in the credit card statement to associate the names or codes with particular merchants. For example, the name of the merchant 128 may be consistently abbreviated in credit card statements, according to certain rules or standards, because the name is longer than the limited number of characters available in the statement. In such a situation, the transaction engine 104 learns to recognize the abbreviated or cryptic version of the merchant's name (e.g., through the use of look-up tables, pattern recognition, or data available from credit card aggregators), such that transactions listed with the abbreviated name may be automatically and directly associated with the merchant 128.

In some implementations, a master database is maintained that includes merchants from past transactions. The database stores a link between “friendly” merchant names (i.e., names of merchants as used in merchant websites or other merchant databases, such as YELP) and “non-friendly” merchant names (i.e., names of merchants as they appear in a credit card statement for a credit card transaction). In some instances, the non-friendly merchant name is created or used by an aggregator or payment processor who works on behalf of the merchant.

In some implementations, if a non-friendly merchant name is unknown, the non-friendly merchant name can be generated from the corresponding friendly merchant name using one or more automated techniques. For example, the non-friendly merchant name can comprise a substring of the friendly merchant name, or a concatenation of substrings from the friendly merchant name. The substring or substrings can be selected using rules that truncate or abbreviate friendly merchant names according to how such names typically appear in credit card transactions. The rules can be automatically deduced from training data comprising friendly and non-friendly versions of merchant names. For example, a given rule specifies for one or more parts of a merchant friendly name, a respective transformation of that part until a non-friendly name is obtained.

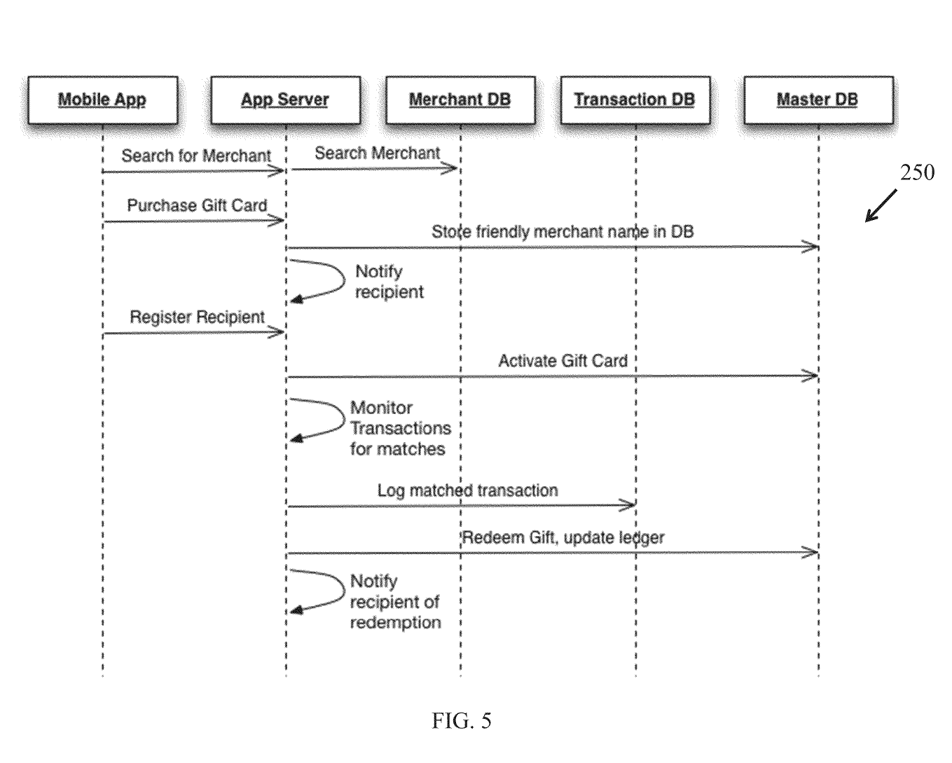

Referring to FIG. 5, a method 250 is utilized to match friendly merchant names with non-friendly merchant names. As depicted, when a non-friendly merchant name for a credit card transaction matches the friendly name of a merchant, the system 100 may associate the two names and add the association to a link table for future access or look-up. In some instances, a Levenshtein distance is calculated for the friendly and non-friendly names. If the Levenshtein distance is determined to be within a certain predefined tolerance or threshold, the system 100 associates the two names. The matching algorithm may perform a number of computations and statistical tests in order to determine the probability of a match between the friendly and non-friendly names. The system preferably learns over time and factors in additional information such as location, business category, and prior matches, to continually improve its accuracy and ability to match based on learned patterns for abbreviated and modified merchant names. If the system 100 determines the match to be within a certain predefined tolerance or threshold, the system 100 associates the two names and stores the matched non-friendly name and associated metadata to a look-up table to improve future matches.

In general, the matching algorithm is used to match a merchant name with a payee name in a consumer's credit card or debit card statement. Due to intermediary processors, acquiring banks, merchant aggregators, etc., the payee name for a credit card or debit card transaction may be different from the actual or recognized business name of the payee or merchant. The matching algorithm is designed to calculate a likelihood that a given payee name is a variant, abbreviation, short form, or a close match of a given merchant name. This is an important step for obtaining a successful match and subsequently redeeming a digital gift card transaction. In one example, the matching algorithm receives a payee name as input and provides as output a best match for a merchant name, along with a matching score.

The systems and methods described herein preferably develop and maintain an adaptive set of reference tables or databases for a set of merchants and their associated payee names. The reference tables may grow and/or adapt as more merchants are encountered. The reference tables preferably include or access a set of words (e.g., in English or other languages) and their known abbreviations.

The matching algorithm includes several steps for identifying a merchant name associated with a payee name, as the payee name appears in a credit card or debit card statement. The algorithm may remove all common words (e.g., “a,” “the,” “and,” “or,” etc.) from the payee name, based on a customizable list of common words. Special characters (e.g., “$,” “/,” “%,” “@,” etc.) may also be removed from the payee name, and a sorted array object may be created. For each record in the merchant reference table, the algorithm obtains the merchant name and merchant location (e.g., business address or store address).

In one example, the matching algorithm performs the following steps for each word in the payee name. If the word matches a word in the merchant name, (i) a matching index for the word is fetched from the system reference table, where each word is given a matching score depending on its relative occurrence in everyday usage; and (ii) an element score E is assigned to be the matching score for the word. Otherwise, if the Levenshtein distance between the word and the current word in the merchant name is less than 5 (or some other suitable threshold value), then the element score for the word is E=20−Levenshtein distance. Otherwise, if the word matches the merchant city name, then the element score for the word is E=30. Otherwise, if the word matches the abbreviation of a word in the merchant name, the element score for the word is E=20. Otherwise, if the word matches an abbreviation of any word in the merchant name, the element score for the word is E=20. Otherwise, the element score is E=0.

Next, a merchant score is determined from S=Σᵢ₌₁^{N}Eᵢ, where N is the number of words in the payee name and Eᵢ is the element score for the i^{th} word. The merchant name and merchant score are stored in the sorted array with score as the index. The matching algorithm returns the topmost merchant name (at index 0 in the sorted array) along with its score to a calling program.

Referring again to FIGS. 2-4, at step 138, the recipient 126 purchases a product or service at the merchant 128 using the recipient's credit card. The transaction engine 104 detects (step 140) the recipient's transaction and sends instructions to the payment device 106 to credit the recipient's credit card, using funds available in escrow. If the amount of the transaction is less than or equal to the value of the electronic gift card, the payment device 106 will send (step 142) the credit to the recipient's credit card in an amount equal to the amount of the transaction. If the amount of the transaction is greater than the value of the electronic gift card (e.g., a $120 purchase with a $100 electronic gift card), the payment device 106 will send a credit to the recipient's credit card in an amount equal to the present value of the electronic gift card. In this way, the recipient 126 is automatically reimbursed for purchases made at the merchant 128 using the recipient's credit card. At step 144, the recipient 126 is notified that the recipient's credit card has received a credit for the purchase with the merchant 128. Any balance remaining on the electronic gift card after the purchase may be applied to a subsequent transaction between the recipient 126 and the merchant 128.

In certain implementations, owners or operators of the transaction engine 104 may charge a transaction fee to cover costs associated with the use of the electronic gift card system 100 and the transaction engine 104. For example, the transaction engine 104 may send (step 146) instructions to the payment device 106 to deliver an invoice to the merchant 128 for the transaction fee. The invoice is delivered (step 148) to the merchant 128, and any payments received from the merchant 128 are deposited (step 150) in an account associated with the owners or operators of the transaction engine 104. In general, the transaction fee is charged to partner merchants who have agreed to use the electronic gift card system 100 to facilitate transactions with customers. For transactions involving non-partner merchants, the transaction fee or a similar processing fee may be charged to the donor 124 (e.g., when the electronic gift card is purchased).

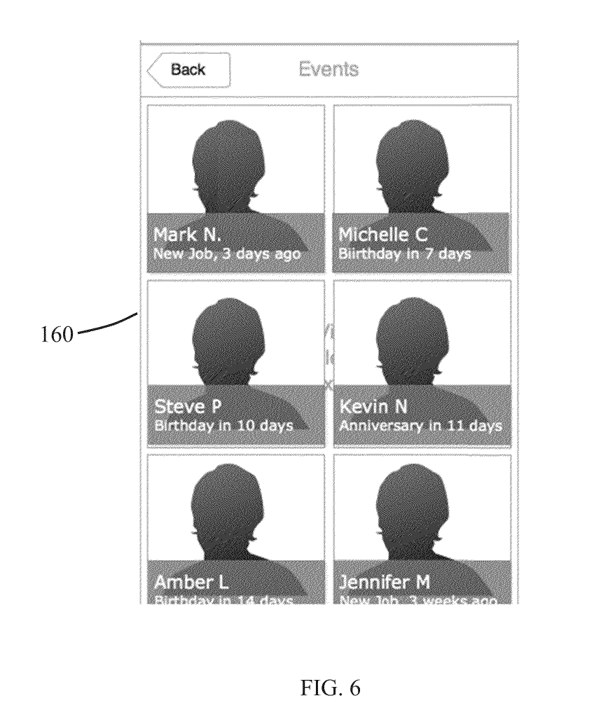

FIG. 6 is an illustrative screenshot 160 of an application for performing the systems and methods described herein. As depicted, the systems and methods may allow a user (e.g., the donor 124 or recipient 126) of the electronic gift card system 100 to track upcoming events for which the user may wish to send an electronic gift card. For example, the system 100 may display upcoming birthdays or anniversaries associated with the user's friends or family.

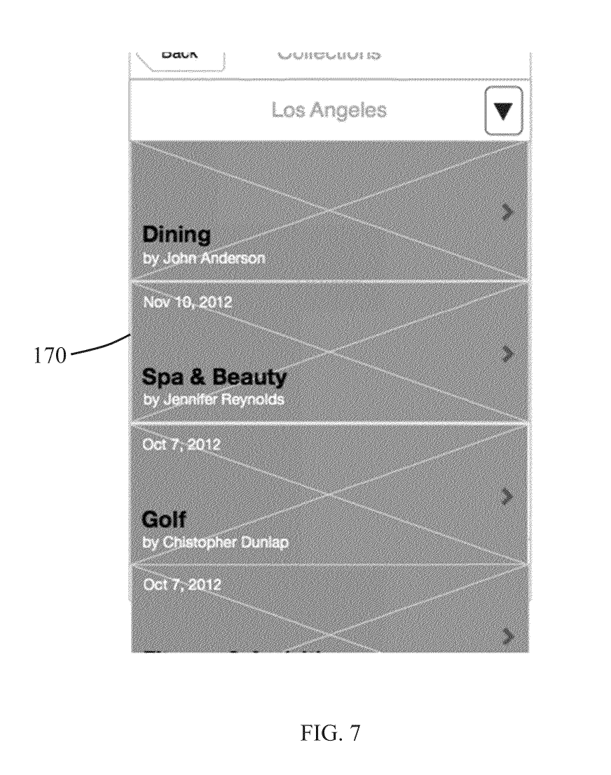

FIG. 7 is an illustrative screenshot 170 showing an implementation of the system 100 in which a user is able to search for and/or prepare a wish list of his or her favorite merchants (e.g., restaurants, coffee shops, and other retail stores). The user can share the wish list with friends and family, who may share their lists with the user. Such lists allow the donor 124 to identify the recipient's favorite merchants when purchasing a gift card and selecting a merchant for the recipient 126.

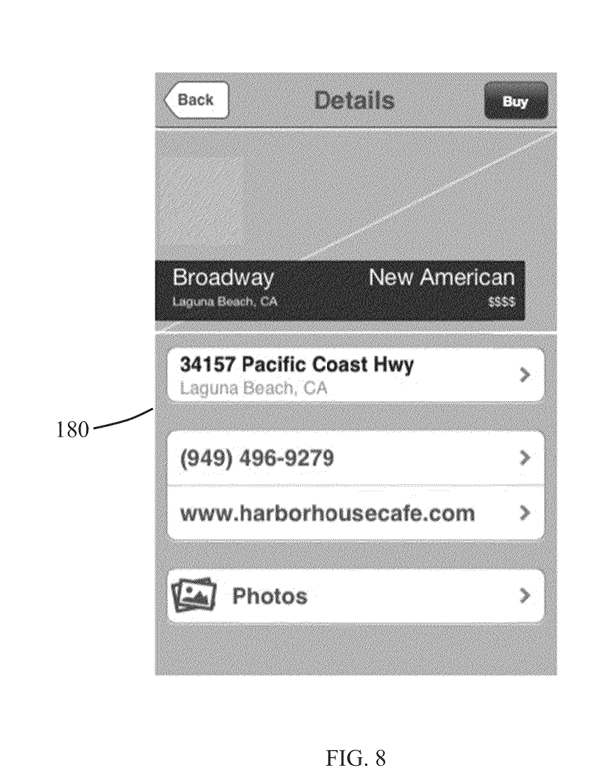

FIG. 8 is an illustrative screenshot 180 showing an implementation of the system 100 in which a user is able to search for merchants for an electronic gift card. The user may search for any business in the marketplace, in any location. For example, the user may search for merchants in a geographical area near the recipient's home. Advantageously, the user may purchase a gift card for any merchant, regardless of whether the merchant has agreed to participate in the system 100 (i.e., a partner merchant) or not (i.e., a non-partner merchant), and regardless of whether the merchant is utilizing a separate gift card or gift certificate system. In general, the merchant 128 may be any business capable of receiving payment from the recipient 126 (e.g., with the recipient's credit card or debit card).

FIG. 9 is an illustrative screenshot 190 showing an implementation of the system 100 in which the donor 124 is able to input information about an electronic gift card to be purchased. For example, the donor 124 may specify a dollar amount, the name and contact information (e.g., an email address or a phone number) for the recipient 126, and the donor's credit card information. The donor 124 may also add a personal note for delivery to the recipient 126. The donor 124 may specify a cause or charity associated with the electronic gift card. For example, for partner merchants, the system 100 may allow the donor 124 or recipient 126 to designate a cause or charity to receive a portion of profits or revenue associated with the purchase. The owner or operator of the system 100 or the transaction engine 104 may make the contribution directly, e.g., as a registered commercial co-venture. The payment may be made by ACH or check to the registered cause. In some instances, the donor 124 may be more than one person. For example, as depicted, the system 100 may allow one donor to invite other individuals to contribute towards the electronic gift card for the recipient 126. When more than one donor contributes to the electronic gift card, the system 100 may accept payment information (e.g., credit card information) from one or more of the donors 124.

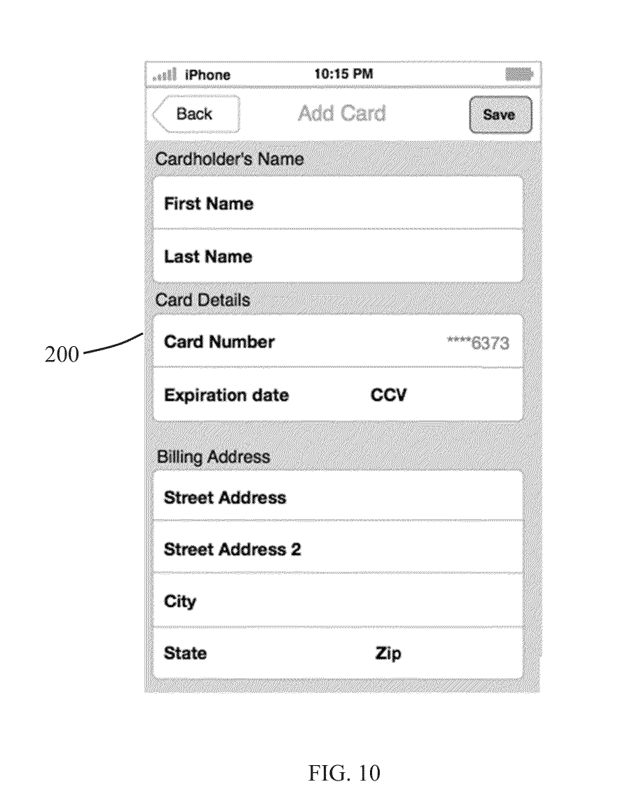

FIG. 10 is an illustrative screenshot 200 showing an implementation of the system 100 in which the donor 124 provides information about a credit card to be used for purchasing electronic gift cards. In the depicted implementation, the donor 124 is able to capture and display a picture of the donor's credit card.

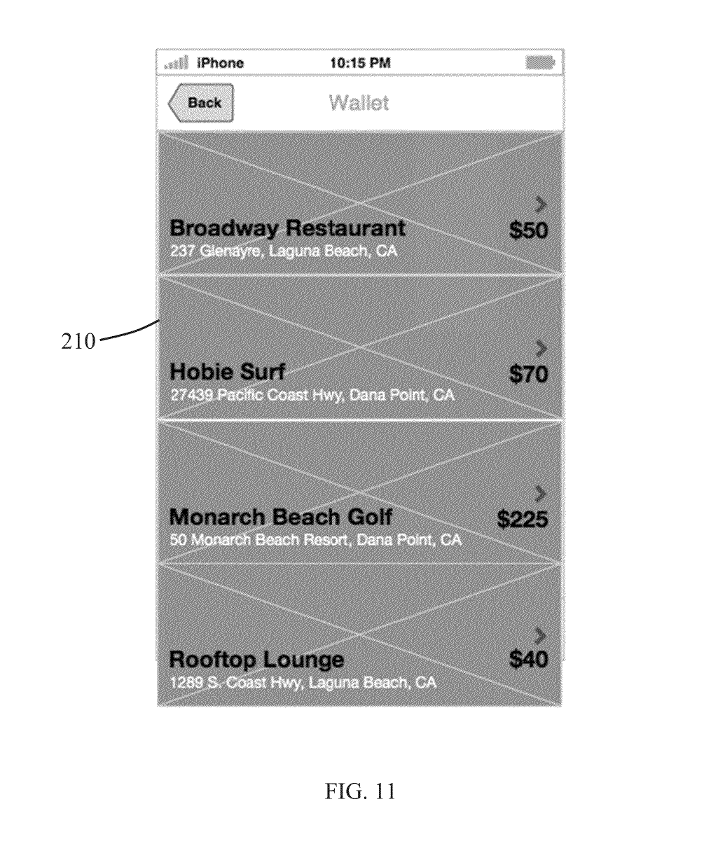

FIG. 11 is an illustrative screenshot 210 showing an implementation of the system 100 in which the donor 124 can view a history of electronic gift cards that the donor 124 has purchased. The history may show the status of each electronic gift card, including an indication of whether or not the electronic gift card has been redeemed.

FIG. 12 is an illustrative screenshot 220 showing an implementation of the system 100 in which the recipient 126 has received an electronic gift card from one or more donors 124. A personalized message from the donors 124 has been delivered to the recipient 126. Instructions for redeeming the electronic gift card are provided to the recipient 126. In the depicted example, the recipient 126 accepts the electronic gift card by selecting the “save gift to credit card” button 222.

FIG. 13 is an illustrative screenshot 230 showing an implementation of the system 100 in which the recipient 126 provides the recipient's credit card information, including a credit card number. The recipient 126 is also prompted to provide credit card account login information, so the system 100 may monitor the recipient's credit card transactions to identify a transaction associated with the merchant 128 for the electronic gift card. In some implementations (e.g., when the merchant 128 is a partner merchant), the system 100 may be able to monitor the merchant's transactions to identify a transaction between the recipient 126 and the merchant 128. In such a case, the system 100 may not use or require the recipient's credit card account login information.

To monitor a partner merchant's transactions, the system 100 may utilize the services of a technology partner. The technology partner may monitor the merchant's transactions and flag any transactions associated with a particular credit card number (i.e., the recipient's credit card number). The transaction engine 104 may receive an immediate alert about such transactions and the corresponding amount(s). In some instances, credit card networks and/or services are used for this monitoring service. In one implementation, the system 100 receives a list of transactions for a set of registered credit cards (e.g., recipient credit cards), which may be provided in a batch file (e.g., monthly). To redeem electronic gifts, the system 100 monitors transactions at merchants for gift recipients. In certain instances, the transaction engine 104 may receive an immediate alert about such transactions and the corresponding amount(s). In other instances, the system 100 receives a list of transactions for a set of registered credit cards (e.g., recipient credit cards), which may be provided in a batch file several times per day. The novel techniques used in the system 100 enable verifiable gift redemption at specific merchants and maintenance of a ledger for specific users at each specific merchant regardless of whether or not the merchant has signed up for virtual gift card services.

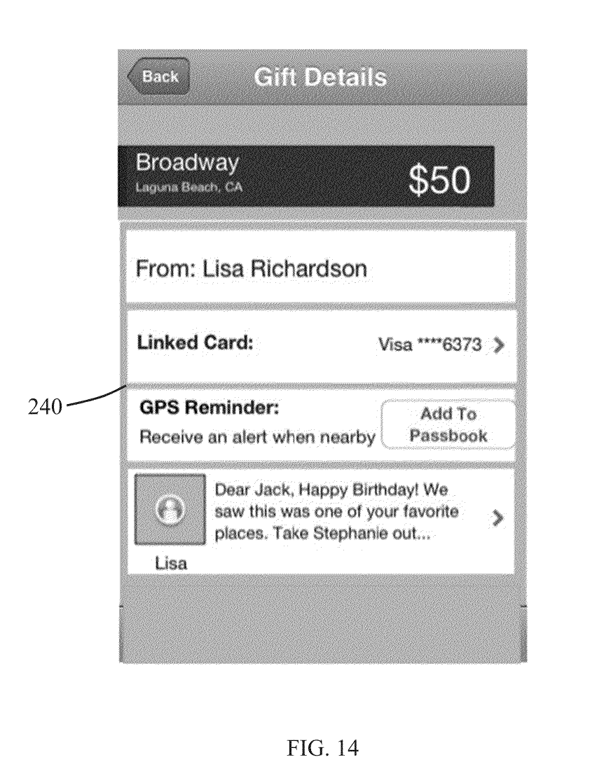

FIG. 14 is an illustrative screenshot 240 showing an implementation of the system 100 in which the recipient 126 can view information about the electronic gift card. The displayed information may include, for example, an identification of the recipient's credit card associated with the electronic gift card, an indication of the amount of money remaining on the electronic gift card, information about a cause supported by the electronic gift card, and/or a personalized note received from the donor 124. The system 100 may allow the recipient 126 to prepare and send thank you notes to the donor(s) 124. The thank you notes may be stored for later review.

In some implementations, the systems and methods described herein notify the recipient 126 when the recipient 126 is in the vicinity of a merchant facility or store. For example, the systems and methods may monitor the location of the recipient 126 relative to the merchant's stores (e.g., using cell phone triangulation or GPS). When the recipient 126 is within a certain threshold distance of a merchant store (e.g., 1 mile), a notification may be sent to the recipient device 108 to inform the recipient of the nearby store.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request by a donor to purchase a scrip for a recipient in a respective amount, wherein the scrip can be applied to a purchase by the recipient from a merchant associated with the scrip;
notifying the recipient of the scrip;
receiving the recipient's acceptance of the scrip in response to the notification, wherein the acceptance indicates an account of the recipient;
debiting the amount from an account of the donor;
electronically monitoring over time at least one of an account of the merchant and the account of the recipient, to identify a purchase from the merchant by the recipient; and
based on identifying the purchase, crediting the account of the recipient by a first amount based on the amount of the scrip.

2. The method of claim 1 wherein the scrip is an electronic gift card.

3. The method of claim 1 wherein the scrip represents a credit amount in a particular currency.

4. The method of claim 1, further comprising, after debiting the account of the donor, holding the amount of the scrip in an escrow account.

5. The method of claim 4 wherein crediting the account of the recipient comprises releasing the first amount from the escrow account.

6. The method of claim 1, further comprising invoicing the merchant associated with the scrip for a transaction fee.

7. The method of claim 6, further comprising receiving payment for the transaction fee.

8. The method of claim 1, further comprising notifying the recipient of the credit to the account of the recipient.

9. The method of claim 1 wherein:
the donor is at least one individual, business entity, or organization; and
wherein the recipient is at least one individual, business entity, or organization.

10. The method of claim 1, further comprising notifying the donor that the scrip has been redeemed.

11. The method of claim 1 wherein the notifying is by electronic mail or short message service, or by multimedia messaging service.

12. The method of claim 1, further comprising notifying the recipient when a location of a client device of the recipient is within a geographical area of the merchant.

13. The method of claim 1, further comprising:
receiving a request by the recipient to change the merchant to a different merchant; and
based on the request to change the merchant, associating the scrip with the different merchant.

14. The method of claim 1, further comprising:
providing a description of one or more merchants to the donor, wherein each of the merchants is located within a geographical area specified by the donor;
receiving selection of one of the merchants by the donor; and
associating the selected merchant with the scrip.

15. The method of claim 1 wherein the first amount is equal to the amount of the scrip or is the lesser of an amount of the purchase and the amount of the scrip.

16. The method of claim 1, further comprising:
deducting the first amount from the scrip amount;
electronically monitoring the account of the recipient over time to identify a subsequent purchase from the merchant by the recipient; and
based on identifying the subsequent purchase, crediting the account of the recipient by a second amount based on a remaining amount of the scrip.

17. The method of claim 16 wherein the second amount is the lesser of an amount of the subsequent purchase and a remaining amount of the scrip.

18. The method of claim 1, further comprising receiving a wish list of merchants from the recipient.

19. A system comprising:
a computer readable medium having instructions stored thereon; and
a data processing apparatus configured to execute the instructions to perform operations comprising:
receiving a request by a donor to purchase a scrip for a recipient in a respective amount, wherein the scrip can be applied to a purchase by the recipient from a merchant associated with the scrip;
notifying the recipient of the scrip;
receiving the recipient's acceptance of the scrip in response to the notification, wherein the acceptance indicates an account of the recipient;
debiting the amount from an account of the donor;
electronically monitoring over time at least one of an account of the merchant and the account of the recipient, to identify a purchase from the merchant by the recipient; and
based on identifying the purchase, crediting the account of the recipient by a first amount based on the amount of the scrip.

20-36. (canceled)

37. A computer program product stored in one or more storage media for controlling a processing mode of a data processing apparatus, the computer program product being executable by the data processing apparatus to cause the data processing apparatus to perform operations comprising:
receiving a request by a donor to purchase a scrip for a recipient in a respective amount, wherein the scrip can be applied to a purchase by the recipient from a merchant associated with the scrip;
notifying the recipient of the scrip;
receiving the recipient's acceptance of the scrip in response to the notification, wherein the acceptance indicates an account of the recipient;
debiting the amount from an account of the donor;
electronically monitoring over time at least one of an account of the merchant and the account of the recipient, to identify a purchase from the merchant by the recipient; and
based on identifying the purchase, crediting the account of the recipient by a first amount based on the amount of the scrip.

38-54. (canceled)
